(19) United States
(12) Patent Application Publication
(10) Pub. No.: US 2007/0288381 A1
(43) Pub. Date: Dec. 13, 2007

(54) Methods of a financial institution monitoring operation of an image-based check clearing process

(75) Inventor: Wayne M. Doran, Kitchener (CA)

Correspondence Address: Intellectual Property Section;Law Department, NCR Corporation, 1700 South Patterson Blvd., Dayton, OH, 45479-0001, US

(73) Assignee: NCR Corporation

(21) Appl. No.: 11/434,682

(22) Filed: May 16, 2006

(51) Int. Cl. G06Q 40/00

(52) U.S. Cl. 705/45

(57) ABSTRACT

A method of a financial institution monitoring operation of a check return clearing process comprises recording a first date/time value at which a transit check item is being processed at a first service location of the check return clearing process, recording a second date/time value at which a returned check item is being processed at a second service location of the check return clearing process, and storing the first and second date/time values in a data repository to allow an analyst to query the data repository and perform analysis of operation of the check return clearing process based upon the stored date/time values.

### BACKGROUND

The present invention relates to check clearing processes, and is particularly directed to methods of a financial institution, such as a bank, monitoring operation of an image-based check clearing process.

A typical image-based check clearing process of a bank includes a number of sub-processes. One sub-process is usually a check in-clearing process in which physical checks (or electronic images of the checks) which have been deposited at collecting banks are received from these collecting banks. The bank then processes the physical checks which have been received from the collecting banks. Items are posted and any exception items which need to be returned to the collecting banks are identified. The identified exception items are then returned to the collecting banks.

Another sub-process is usually a check return clearing process in which physical checks (or electronic images of the checks) which have been cleared by the bank and subsequently forwarded to other banks are returned from these other banks. The bank then processes the physical checks which have been returned from the other banks to identify and post any items which need to be returned to the bank's customers.

Time is required to process items which have been returned from other banks. A drawback in known check in-clearing processes or known return clearing processes is the difficulty in knowing where inefficiencies or bottlenecks in the processes may be occurring. It would be desirable to provide a system analyst with useful information so that inefficiencies or bottlenecks which may be present in the processes can be identified and corrected so that exception items can be identified and processed sooner rather than later.

### SUMMARY

In accordance with one aspect of the present invention, a method of a financial institution monitoring operation of a check return clearing process comprises recording a first date/time value at which a returned check item is being processed at a first service location of the check return clearing process, recording a second date/time value at which the returned check item is being processed at a second service location of the check return clearing process, and storing the first and second date/time values in a data repository to allow an analyst to query the data repository and perform analysis of operation of the check return clearing process based upon the stored date/time values.

In accordance with another aspect of the present invention, a method of a financial institution monitoring operation of a check return clearing process comprises recording a first date/time value at which a transit check item is being processed at outgoing exchange services, recording a second date/time value at which a returned check item is being processed at incoming returns services, and storing the first and second date/time values in a data repository to allow an analyst to query the data repository and perform analysis of operation of the check return clearing process based upon the stored date/time values.

In accordance with yet another aspect of the present invention, a method of a financial institution monitoring operation of a check in-clearing process comprises recording a first date/time value at which an in-clearing check item is being processed at a first service location of the check in-clearing process, recording a second date/time value at which the in-clearing check item is being processed at a second service location of the check in-clearing process, and storing the first and second date/time values in a data repository to allow an analyst to query the data repository and perform analysis of operation of the check in-clearing process based upon the stored date/time values.

### BRIEF DESCRIPTION OF THE DRAWINGS

In the accompanying drawings:

FIG. 1 is a block diagram representation of a known image-based check clearing process;

FIG. 2 is a block diagram similar to FIG. 1 and shows one embodiment of the present invention;

FIG. 3 is a block diagram similar to FIG. 1 and shows another embodiment of the present invention and

FIG. 4 is a block diagram similar to FIG. 1 and shows yet another embodiment of the present invention.

### DETAILED DESCRIPTION

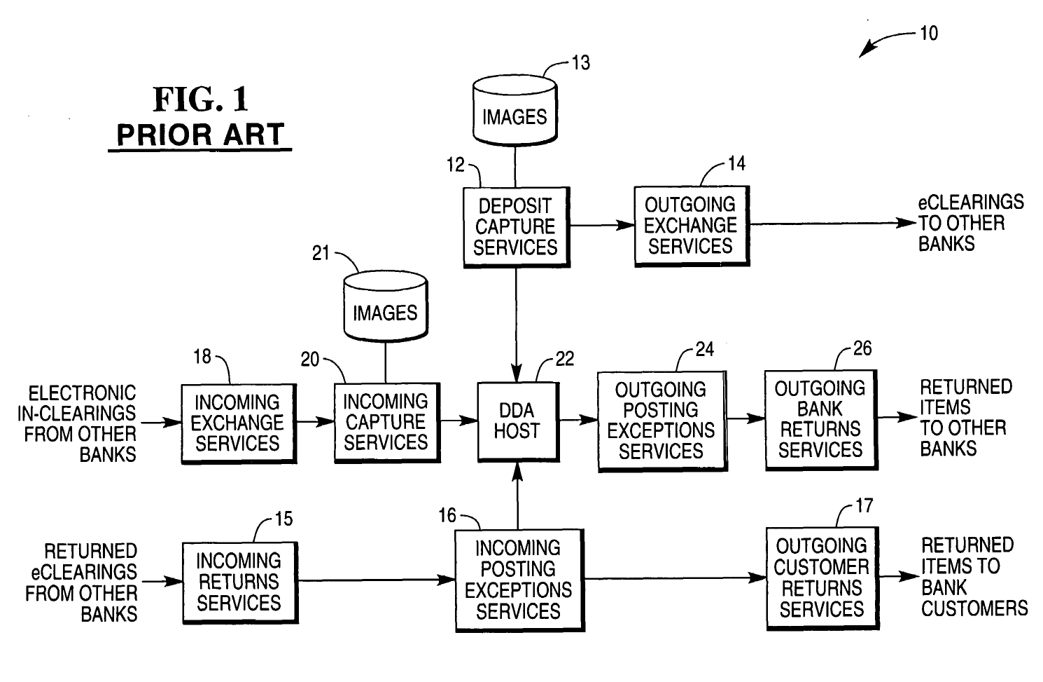

A known image-based check clearing process 10 is shown in FIG. 1. The image-based check clearing process 10 includes deposit capture services 12 in which images of deposit items (such as bank checks) are initially captured at remote capture points (such as branch teller stations, automated teller machines, point-of-sale terminals, and merchant/corporate terminals). The captured check images are consolidated, stored in image data memory 13, and then processed in a back office facility of a financial institution (such as a bank). The processing in the back office facility of the bank includes activities such as recognition, codeline completion, amount keying, balancing and reconciliation, and encoding. During processing in the back office facility, check data associated with processed on-us checks are stored in a demand deposit account (DDA) host computer 22. The processing of checks through deposit capture services 12 is well known and, therefore, will not be described.

Also, as shown in FIG. 1, outgoing exchange services 14 receives check images from deposit capture services 12 and processes the check images to prepare those check images which are to be electronically transmitted to other banks to clear the checks. Those check images electronically transmitted to other banks are known as “eClearings”. The processing of check images through outgoing exchange services 14 is well known and, therefore, will not be described.

From time to time, some of the eClearings which have been electronically transmitted to other banks are returned from these banks for various reasons. Incoming returns services 15, as shown in FIG. 1, processes these returned eClearings in a known manner. Afterwards, incoming posting exceptions services 16 posts any of the returned eClearings which have been identified as being posting exception items. The DDA host computer 22 is updated with information about posting exception items which have been identified. Outgoing customer returns services 17 then processes the identified posting exception items in known manner to return these items to the bank's customers.

The image-based check clearing process 10 further includes incoming exchange services 18 which receive electronic in-clearings from other banks (i.e., eClearings which have been transmitted from these other banks). Incoming exchange services 18 prepares the electronic in-clearings for further processing in known manner. Incoming capture services 20 then processes the electronic in-clearings in known manner, stores check image data in image data memory 21, and stores check data in the DDA host computer 22 to post the items.

Outgoing posting exceptions services 24 retrieves data from the DDA host computer 22, and then identifies any exception items which are to be returned. Outgoing bank returns services 26 receives the in-clearings which have been identified as exception items which are to be returned, and returns the exception items back to the banks from which the in-clearings were originally received. The processing of in-clearings through outgoing bank returns services 26 is well known and, therefore, will not be described.

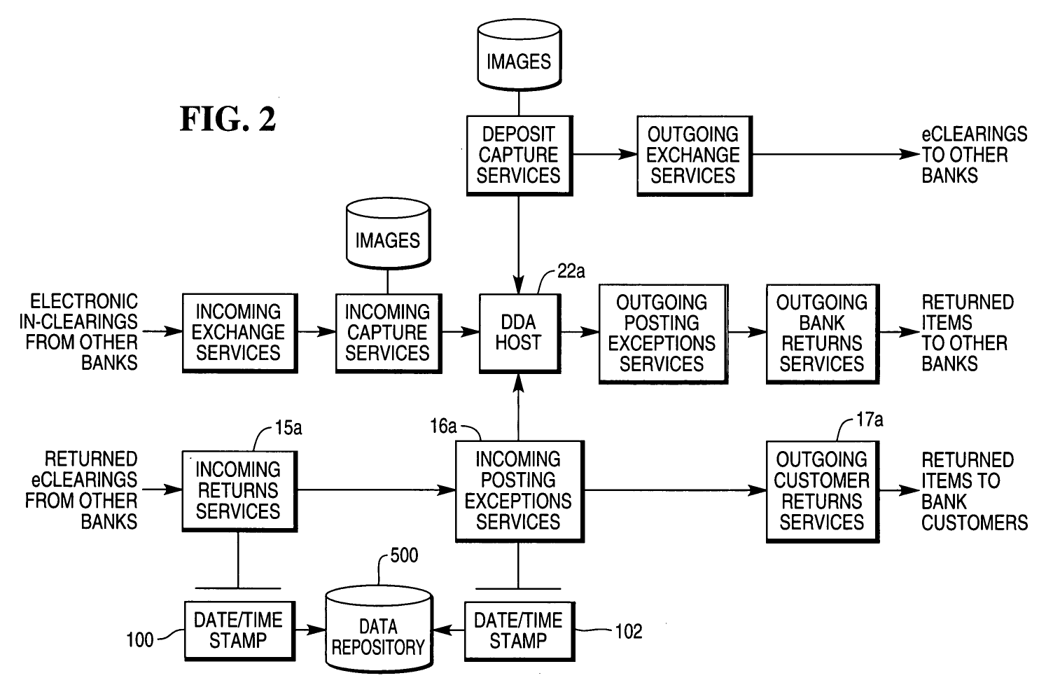

One embodiment of present invention is illustrated in FIG. 2. The diagram illustrated in FIG. 2 is similar to the diagram illustrated in FIG. 1. Accordingly, similar numerals are utilized to designate similar components, the suffix letter “a” being associated with the diagram of FIG. 2 to avoid confusion.

As shown in FIG. 2, a date/time stamp 100 is associated with incoming returns services 15a. The date/time stamp 100 provides a date value or a time value, or both, which is associated with each item processed through incoming returns services 15a. The date value (referred to herein as “the date”) may include, for example, the month, day, and year the particular item was processed through incoming returns services 15a. It is conceivable that the date may include more or less information than the month, day, and year. For example, the date may include just the month and day. The time value (referred to herein as “the time”) may include, for example, the hour and the minute the particular item was processed through incoming returns services 15a. It is conceivable that the time may include more or less information than the hour and the minute. For example, the time may include the hour, the minute, and the second. After the date or the time, or both, has been associated with a particular item, this date/time stamp information is stored along with check data which is representative of the particular item in a data repository 500. Check image data may also be stored in the data repository 500. The data repository 500 is of a type which can be queried by a system analyst to analyze the data stored in the data repository. For example, the data repository 500 may be a Teradata Enterprise data warehouse provided by NCR Corporation, located in Dayton, Ohio.

Also, as shown in FIG. 2, a date/time stamp 102 is associated with incoming posting exceptions services 16a. The date/time stamp 102 provides a date value (“date”) or a time value (“time”), or both, which is associated with each item processed through the incoming posting exceptions services 16a. The date may also include, for example, the month, day, and year the particular item was processed through incoming posting exceptions services 1a. The time may include, for example, the hour and the minute the particular item was processed through incoming posting exceptions services 16a. After the date or the time, or both, has been associated with a particular item, this date/time stamp information is stored along with check data which is representative of the particular item in the data repository 500. Outgoing customer returns services 17a then processes the identified items to return these items to the bank's customers.

It should be apparent that for any particular item in question, the time of the date/time stamp 100 associated with incoming postings exceptions services 16a will be later than the time of the date/time stamp 100 associated with incoming returns services 15a. The date of the date/time stamp 102 associated with incoming posting exceptions services 16a may be later than the date of the date/time stamp 100 associated with incoming returns services 15a. If the date of the date/time stamp 102 is not later than the date of the date/time stamp 100, then the dates will be the same.

By storing the time and/or date of the date/time stamp 102 and the time and/or date of the date/stamp 100 in the data depository 500, a system analyst is able to query this stored data and analyze the data to determine how much time elapsed from when a particular item was processed at incoming returns services 15a to when the item was processed at incoming posting exceptions services 16a. By allowing the system analyst to determine this elapsed amount of time, the analyst is able to identify inefficiencies or bottlenecks which may be present in the process flow between incoming returns services 15a and incoming posting exceptions services 16a. When inefficiencies or bottlenecks are identified, corrective action may be taken to streamline the process flow between incoming returns services 16a and incoming posting exceptions services 24a. The result is an improved process flow in which returned items can be processed relatively faster, and in which the DDA host computer 22a can be updated sooner with information that an item has been returned.

Although above-description describes a date/time stamp being at incoming returns services 15a and a date/time stamp being present at incoming posting exceptions services 16a, it is conceivable that date/time stamps may be present at other locations of the process. For example, a date/time stamp may be at outgoing customer returns services 17a. It is also conceivable that date/stamps may be located at any combination of incoming returns services 15a, incoming posting exceptions services 16a, outgoing customer returns services 17a, and other services which may be in the flow of processing returned eClearings from other banks. Further, it is conceivable that any number of date/time stamps may be located within any one of incoming returns services 15a, incoming posting exceptions services 16a, outgoing customer returns services 17a, and other services which may be in the flow of processing returned eClearings from other banks.

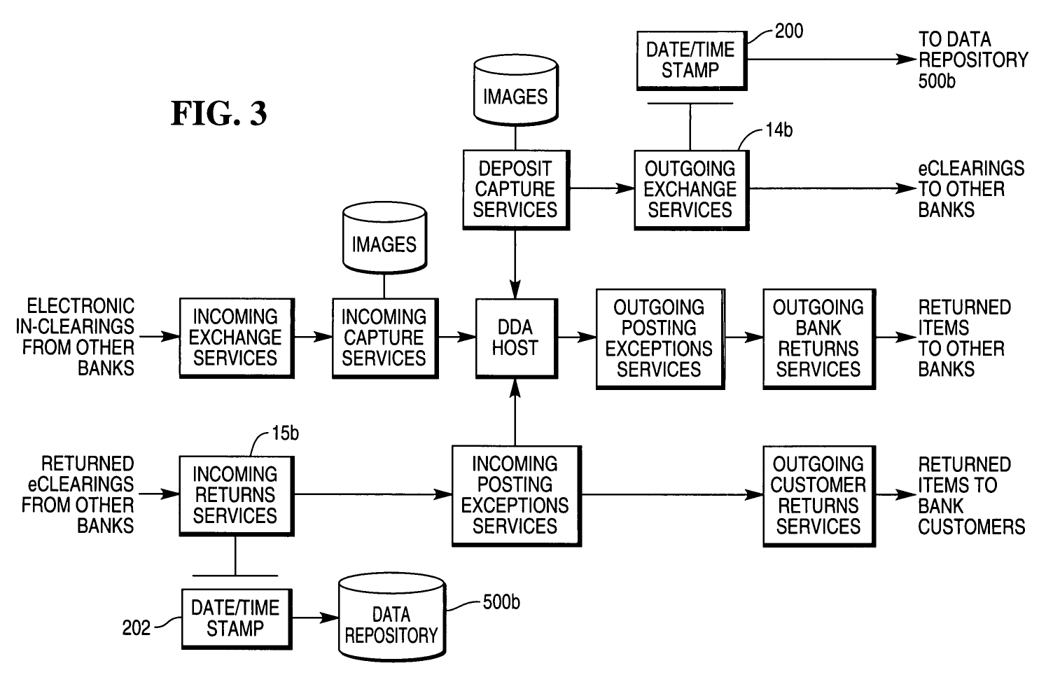

A second embodiment of the present invention is illustrated in FIG. 3. Since the embodiment of the invention illustrated in FIG. 3 is generally similar to the embodiment illustrated in FIG. 2, similar numerals are utilized to designate similar components, the suffix letter “b” being associated with the embodiment of FIG. 3 to avoid confusion.

As shown in FIG. 3, a date/time stamp 200 is associated with outgoing exchange services 14b. The date/time stamp 200 provides a date value (“date”) or a time value (“time”), or both, which is associated with each item processed through outgoing exchange services 14b. After the date or the time, or both, has been associated with a particular item, this date/time stamp information is stored along with check data which is representative of the particular item in the data repository 500b.

Also, as shown in FIG. 3, a date/time stamp 202 is associated with incoming returns services 15b. The date/time stamp 202 provides a date or a time, or both, which is associated with each item processed through the incoming returns services 15b. After the date or the time, or both, has been associated with a particular item, this date/time stamp information is stored along with check data which is representative of the particular item in the data repository 500b.

It should be apparent that for any particular item in question, the time of the date/time stamp 202 associated with incoming returns services 15b will be later than the time of the date/time stamp 200 associated with outgoing exchange services 14b. The date of the date/time stamp 202 associated with incoming returns services 15b may be later than the date of the date/time stamp 200 associated with outgoing exchange services 14b. If the date of the date/time stamp 202 is not later than the date of the date/time stamp 200, then the dates will be the same.

By storing the time and/or date of the date/time stamp 202 and the time and/or date of the date/stamp 200 in the data depository 500b, a system analyst is able to query this stored data and analyze the data to determine how much time elapsed from when a particular item was processed at outgoing exchange services 14b to when the item was processed at incoming returns services 15b. By allowing the analyst to determine this elapsed amount of time, the analyst is able to identify inefficiencies or bottlenecks which may be present in the process flow between outgoing exchange services 14b and incoming returns services 15b. When inefficiencies or bottlenecks are identified, corrective action may be taken to streamline the process flow between outgoing exchange services 14b and incoming returns services 15b. The result is an improved process flow in which returned eClearings from other banks can be processed relatively sooner.

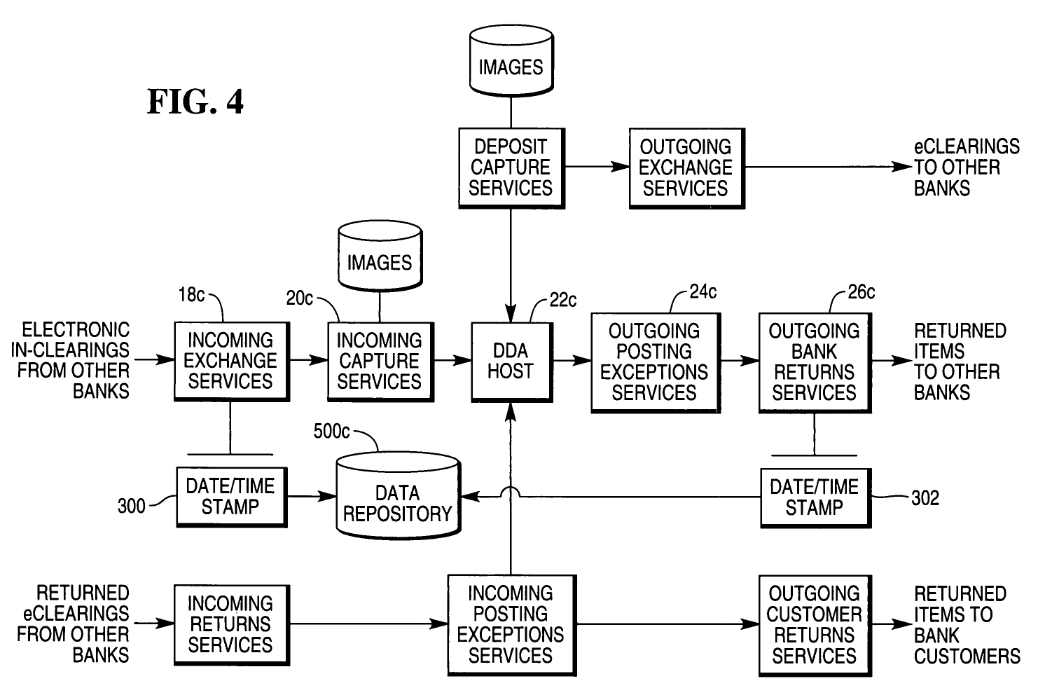

A third embodiment of the present invention is illustrated in FIG. 4. Since the embodiment of the invention illustrated in FIG. 4 is generally similar to the embodiment illustrated in FIG. 3, similar numerals are utilized to designate similar components, the suffix letter “c” being associated with the embodiment of FIG. 4 to avoid confusion.

As shown in FIG. 4, a date/time stamp 300 is associated with incoming exchange services 18c. The date/time stamp 300 provides a date value (“date”) or a time value (“time”), or both, which is associated with each item processed through incoming exchange services 18c. After the date or the time, or both, has been associated with a particular item, this date/time stamp information is stored along with check data which is representative of the particular item in the data repository 500c.

Also, as shown in FIG. 4, a date/time stamp 302 is associated with outgoing bank returns services 26c. The date/time stamp 302 provides a date or a time, or both, which is associated with each item processed through the outgoing bank returns services 26c. After the date or the time, or both, has been associated with a particular item, this date/time stamp information is stored along with check data which is representative of the particular item in the data repository 500c.

It should be apparent that for any particular item in question, the time of the date/time stamp 302 associated with outgoing bank returns services 26c will be later than the time of the date/time stamp 300 associated with incoming exchange services 18c. The date of the date/time stamp 302 associated with outgoing bank returns services 26c may be later than the date of the date/time stamp 300 associated with incoming exchange services 18c. If the date of the date/time stamp 302 is not later than the date of the date/time stamp 300, then the dates will be the same.

By storing the time and/or date of the date/time stamp 302 and the time and/or date of the date/stamp 300 in the data depository 500c, a system analyst is able to query this stored data and analyze the data to determine how much time elapsed from when a particular item was processed at incoming exchange services 18c to when the item was processed at outgoing bank returns services 26c. By allowing the analyst to determine this elapsed amount of time, the analyst is able to identify inefficiencies or bottlenecks which may be present in the process flow between incoming exchange services 18c and outgoing bank returns services 26c. When inefficiencies or bottlenecks are identified, corrective action may be taken to streamline the process flow between incoming exchange services 18c and outgoing bank returns services 26c. The result is an improved process flow in which exception items can be posted and identified sooner, and in which the DDA host computer 22c can be stored sooner with information that an item has been identified as an exception item.

Although above-description of the third embodiment describes a date/time stamp being at incoming exchange services 18c and a date/time stamp being present at outgoing returns services 26c, it is conceivable that date/time stamps may be present at other locations of the process. For example, date/time stamps may be located at incoming capture services 20c and outgoing posting exceptions services 24c. In this case, elapsed times may be determined from when a particular item was processed at incoming capture services 20c to when the item was processed at outgoing posting exceptions services 24c. It is also conceivable that date/stamps may be located at any combination of incoming exchange services 18c, incoming capture services 20c, outgoing posting exceptions services 24c, outgoing bank returns services 26c, and other services which may be in the flow of processing electronic in-clearings from other banks. Further, it is conceivable that any number of date/time stamps may be located within any one of incoming exchange services 18c, incoming capture services 20c, outgoing posting exceptions services 24c, outgoing bank returns services 26c, and other services which may be in the flow of processing electronic in-clearings from other banks.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A method of a financial institution monitoring operation of a check return clearing process, the method comprising:
recording a first date/time value at which a returned check item is being processed at a first service location of the check return clearing process;
recording a second date/time value at which the returned check item is being processed at a second service location of the check return clearing process; and
storing the first and second date/time values in a data repository to allow an analyst to query the data repository and perform analysis of operation of the check return clearing process based upon the stored date/time values.

2. A method according to claim 1, wherein the first service location comprises incoming returns services, and the second service location comprises incoming posting exceptions services.

3. A method according to claim 1, wherein the data repository comprises a data warehouse which can be queried to analyze data stored therein.

4. A method according to claim 1, wherein the each of the first and second time values comprises an hour and a minute of a day.

5. A method according to claim 1, wherein the each of the first and second time values comprises a month, a day, and a year.

6. A method of a financial institution monitoring operation of a check return clearing process, the method comprising:
recording a first date/time value at which a transit check item is being processed at outgoing exchange services;
recording a second date/time value at which a returned check item is being processed at incoming returns services; and
storing the first and second date/time values in a data repository to allow an analyst to query the data repository and perform analysis of operation of the check return clearing process based upon the stored date/time values.

7. A method according to claim 6, wherein the data repository comprises a data warehouse which can be queried to analyze data stored therein.

8. A method according to claim 6, wherein the each of the first and second time values comprises an hour and a minute of a day.

9. A method according to claim 6, wherein the each of the first and second time values comprises a month, a day, and a year.

10. A method of a financial institution monitoring operation of a check in-clearing process, the method comprising:
recording a first date/time value at which an in-clearing check item is being processed at a first service location of the check in-clearing process;
recording a second date/time value at which the in-clearing check item is being processed at a second service location of the check in-clearing process; and
storing the first and second date/time values in a data repository to allow an analyst to query the data repository and perform analysis of operation of the check in-clearing process based upon the stored date/time values.

11. A method according to claim 10, wherein the first service location comprises incoming exchange services, and the second service location comprises outgoing bank returns services.

12. A method according to claim 10, wherein the first service location comprises incoming exchange services, and the second service location comprises outgoing posting exceptions services.

13. A method according to claim 10, wherein the first service location comprises incoming exchange services, and the second service location comprises incoming capture services.

14. A method according to claim 10, wherein the first service location comprises incoming capture services, and the second service location comprises outgoing bank returns services.

15. A method according to claim 10, wherein the first service location comprises outgoing posting exceptions services, and the second service location comprises outgoing bank returns services.

16. A method according to claim 10, wherein the data repository comprises a data warehouse which can be queried to analyze data stored therein.

17. A method according to claim 10, wherein the each of the first and second time values comprises an hour and a minute of a day.

18. A method according to claim 10, wherein the each of the first and second time values comprises a month, a day, and a year.
